(19) United States
(12) Patent Application Publication
(10) Pub. No.: US 2026/0268099 A1
(43) Pub. Date: Sep. 10, 2026

(54) DOCUMENT GENERATION FROM MULTI-MODAL INPUTS

(71) Applicant: Accenture Global Solutions Limited, Dublin (IE)

(72) Inventors: Arjun ATREYA V, Bengaluru (IN); Krishna KUMMAMURU, Bengaluru (IN); Sangita AGARWAL, Bangalore (IN); Tamal BHATTACHARYYA, Bangalore (IN); Harinarayan OJHA, Kannod (IN)

(73) Assignee: Accenture Global Solutions Limited, Dublin (IE)

(21) Appl. No.: 19/069,912

(22) Filed: Mar. 4, 2025

(51) Int. Cl. G06F 40/56; G06F 16/93

(52) U.S. Cl. CPC G06F 40/56; G06F 16/93

(57) ABSTRACT

Method, computing device, and computer program product for generating a document are disclosed. An input associated with the document to be generated is received. Based on the input, an output structure for the document is generated. Further, stored items corresponding to content items of the output structure is identified. Among the stored items, a first portion having a temporal relationship and a second portion that lacks the temporal relationship are determined. From the first portion and the second portion, first features and second features are extracted, respectively. Upon the extraction, correlated features within the first portion of the stored items are identified using natural language content associated with the first features. The correlated features of the first portion are normalized in time. After normalizing the correlated features, the document is generated by processing the first features, the second features, and the output structure.

### TECHNICAL FIELD

Various examples described herein relate generally to method, computer device, and computer program product for generating a document from multi-modal inputs.

### BACKGROUND

Advancements in digitization techniques have changed the dynamics of generating, storing, and representing data. For example, the data may be generated by different devices in different formats for a same event. As a result, immense volumes of data may be generated for the same event. User may require collated data that conveys the most relevant information related to the event for their decision making. Enterprises may employ tools such as document generators, to generate documents by collating the data generated in the different formats from various databases and presenting the collated data in a coherent manner. The documents may include reports, proposals, presentations, and/or the like, which aid the users in analyzing and understanding the data related to the event.

### SUMMARY

In at least one example, the present disclosure provides a method for generating a document. The method includes receiving an input associated with a document to be generated. The input includes one or more parameters including a document type, a purpose, and a description. The method includes obtaining, from a first Large Language Model (LLM), an output structure associated with the document. The output structure includes an ordered hierarchical structure of content items based on the document type. The method includes identifying stored items corresponding to the content items of the output structure, wherein the content items include a plurality of modal output formats, wherein at least a portion of the stored items include temporal content. The method includes determining a first portion of the stored items having a temporal relationship and a second portion of the stored items that do not have the temporal relationship. The method includes extracting first features from the first portion of the stored items and second features from the second portion of the stored items. The method includes identifying correlated features within the first portion of the stored items using natural language content associated with the first features, wherein a first correlated event in a first stored item of the first portion is identified as being correlated to a second correlated event in a second stored item of the first portion having a different mode than the first stored item. The method includes normalizing the correlated features of the first portion in time based on the correlated features. After normalizing the correlated features of the first portion, obtaining, from a second LLM, the document based on the first features, the second features, and the output structure.

The present disclosure further describes a system for implementing the method provided herein. The present disclosure also describes a non-transitory computer-readable storage media having instructions stored thereon which, when executed by one or more processors of a computing device, cause the computing device to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example document generation system for generating a document, in accordance with implementations of the present disclosure.

FIG. 2 depicts an example conceptual block diagram of a document generation manager in a document generator for generating the document, in accordance with implementations of the present disclosure.

FIG. 3 depicts an example process flow of generating the document, in accordance with implementations of the present disclosure.

FIG. 4 depicts an example knowledge graph, in accordance with implementations of the present disclosure.

FIG. 5 depicts an example illustration of identifying correlated features in stored items extracted for generating the document, in accordance with implementations of the present disclosure.

FIGS. 6A and 6B depict example illustrations of generating the document, in accordance with implementation of the present disclosure.

FIG. 7 is a flow diagram that presents an example method for generating the document, in accordance with implementations of the present disclosure.

FIG. 8 depicts an example computer system to implement the document generator, in accordance with implementations of the present disclosure.

Like reference numbers and designations in the various drawings indicate like elements.

### DETAILED DESCRIPTION OF THE DRAWINGS

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter. These configurations may involve additional Artificial Intelligence (AI) powered workflows or advanced algorithms to improve system adaptability and scalability.

Reference to any “example” (e.g., “for example”, “an example of”, by way of example” or the like) are to be considered non-limiting examples regardless of whether expressly stated or not. These examples highlight potential implementations but do not restrict the application to specific use cases or technologies.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification. The flexibility in terminology ensures that evolving industry standards or emerging terminologies can be seamlessly adopted into the system.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control. This ensures consistency and clarity across all described examples and implementations.

The term "comprising" when utilized means "including, but not necessarily limited to"; it specifically indicates open-ended inclusion or membership in the so-described combination, group, series and the like.

A determiner such as the term “a” or “an” means “one or more” unless the context clearly indicates a single element.

Generic numeric labels such as “first,” “second,” etc., are labels to distinguish components or blocks of otherwise similar names but do not imply any sequence or numerical limitation.

“And/or” for two possibilities means either or both stated possibilities (“A and/or B” covers A alone, B alone, or both A and B taken together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples. These details are intentionally modular to ensure adaptability for a wide range of applications and industries.

The specification and drawings are to be regarded in an illustrative rather than a restrictive sense. It will, however, be evident that various modifications and changes may be made thereunto without departing from the broader spirit and scope of the invention as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Multi-modal inputs”, “stored items”, and/or the like, may refer to data/information having multi-modal formats/media types and stored in different sources.

“Content items” and/or the like, may refer to components of a document.

“Correlated features” and/or the like, may refer to features or contents extracted from the stored items and are mutually exclusive describing a same event with different timestamps in different chronological orders. The features are critical for establishing temporal coherence and deriving meaningful relationships across disparate data sources.

Documents are important to both users and enterprises, as the documents are source of knowledge and information accumulation. The documents may be used in various domains such as enterprise operations, corporate services, retail industries (including enterprise applications), healthcare, software development, legal services, industrial equipment, and/or the like. For example, a document related to an enterprise operation may summarize process of invoicing, contracts, communication, and/or the like. The documents may be generated by collating data of different formats from different databases, thereby providing summaries of events to the users.

Manual document generation may be prone to multiple errors and associated with low accuracy. Existing systems may employ tools like a document generator to generate the document using the data extracted from the different databases and of different formats. The document generator may operate based on pre-defined templates or pre-defined rules. The document generator operating based on the pre-defined templates or the pre-defined rules may fail to identify what data is required at any given point in time and to select an appropriate source to extract the identified data for generating the document. Further, the document generator may fail to capture any relationships among the data extracted from the different sources. The generated document may include diverse, redundant, and noisy information. Such a document may be required to be validated and edited manually. As a result, the existing systems may expend a significant amount of time, human resources, and computing resources (e.g., processing resources, memory resources, communication resources, and/or the like) to generate the document.

Aspects of the present disclosure include an automated framework for generating a document from stored items. The stored items may include multi-modal inputs and stored in one or more different sources. The document may be generated by leveraging Artificial Intelligence (AI) and Large Language Models (LLMs) to ensure faster processing, improved accuracy, and deeper contextual insights, which may reduce a manual effort required for generation of the document. In the present disclosure, the document may be generated by (i) generating an output structure for the document; (ii) dynamically identifying the stored items required for the document in accordance with the output structure and associated one or more sources; (iii) extracting the identified stored items from the identified source; and (iv) identifying and normalizing correlated stored items that are having a temporal relationship to generate the document. The document may be generated with high efficiency and accuracy, while reducing consumption of time and computing resources. In addition, automatic generation of the document may enable more consistent and efficient generation of critical documents across multiple domains or industries.

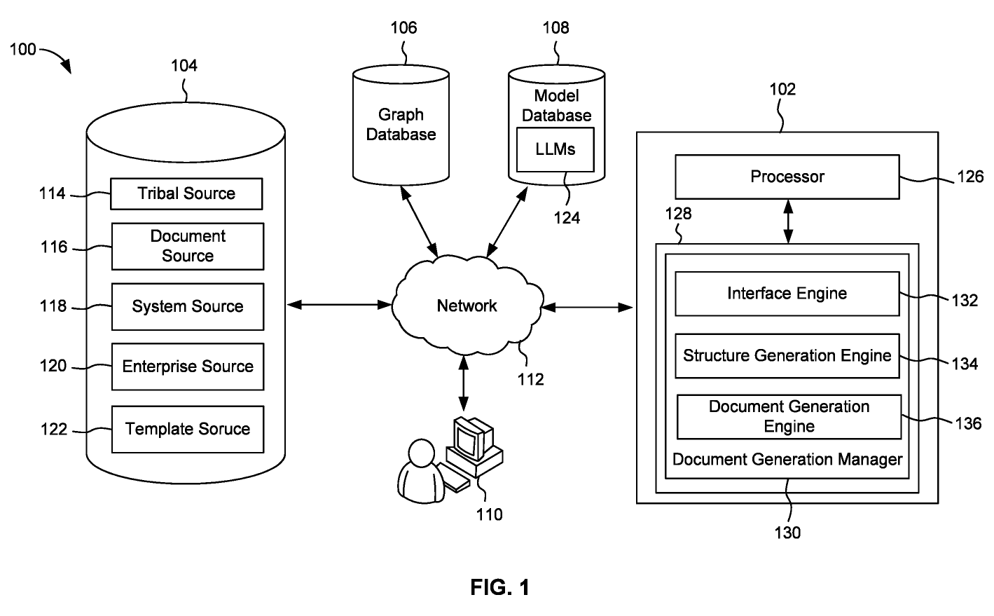

FIG. 1 depicts an example document generation system 100 for generating a document, in accordance with implementations of the present disclosure. In some examples, the document generation system 100 may be used for various domains such as, but are not limited to, enterprise operations, corporate services, retail industries (including enterprise applications), healthcare, software development, legal services, industrial equipment, and/or the like. Non-limiting examples of the document may include a process document, a contract document, a requirement document, a design document, a health report, a legal document, a proposal document, a service agreement, a non-disclosure agreement, and/or the like.

As depicted in FIG. 1, the document generation system 100 includes a document generator 102 (also be referred as a computing device), a federated knowledge base 104, a graph database 106, a model database 108, and a user device 110. The document generator 102 may communicate with the federated knowledge base 104, the graph database 106, the model database 108, and the user device 110 using a network 112. In some examples, the network 112 may include a Local Area Network (LAN), a Wide Area Network (WAN), the Internet, or a combination thereof. In some examples, the network 112 may be accessed over a wired and/or a wireless communication link.

The federated knowledge base 104 may be employed for each of the various domains to store items. In some examples, the federated knowledge base 104 may enable storing of the items in different sources/databases, in accordance with sources to which the items belong to or generated. For simplicity, the federated knowledge base 104 including sources such as, a tribal source 114, a document source 116, a system source 118, an enterprise source 120, and a template source 122, is depicted in FIG. 1. As would be understood by a person skilled in the art that the federated knowledge base 104 may include other similar sources. The tribal source 114 may include the items that have been obtained from trainings, knowledge transfer sessions, presentations, meetings, call recordings, and/or the like, from other third parties. In some examples, Natural Language Processing (NLP) techniques may be used to analyze the items stored in the tribal source 114. Such an analysis of the items may improve insights extraction from the respective items. For example, the tribal source 114 may include the items such as, but are not limited to, training data, knowledge transfer data, process/system walkthrough data, meeting minutes/notes, process analysis data, call data, past presentation data, structured data (e.g., projections), data related to clarifying questions and exception handling, publicly available data, and/or the like. The document source 116 may include the items that have been documented. For example, if the domain includes the enterprise operations, the items in the document source 116 may provide knowledge or standard practices for performing processes or operations of an enterprise. By way of non-limiting example, the items stored in the document source 116 may include Standard Working Instructions (SWIs), Standard Operating Procedures (SOPs), policies, process maps, Frequently Asked Questions (FAQs) and related answers, collaborative platform document (e.g., Wikipedia), and/or the like. The system source 118 may include the items that have been obtained from different integrated systems/databases (e.g., Enterprise Resource Planning (ERP), Customer Relationship Management (CRM), or the like), task mining, process mining, and/or the like. The items stored in the system source 118 may also be obtained from different data lakes, data warehouses, and/or the like, related to specific processes. The enterprise source 120 may include the items that have been specific to a respective enterprise/entity. By way of non-limiting example, the items stored in the enterprise source 120 may identify different stake owners of the enterprise, organizational hierarchies or structures of the enterprise, how different process or components operate in the enterprise, standard base documents illustrating offerings of the enterprise, clients/customers of the enterprise, industries where the clients/customers of the enterprise belong to, and/or the like. The template source 122 may include the items that have been created for maintaining policies, compliance rules, security procedures, process/operations, and/or the like, of the enterprise. Additionally, or alternatively, the template source 122 may include the items, which may provide document templates for generating the document. The document templates may indicate a coverage of the document. For example, the document templates may include golden templates, Failure Mode Effects Analysis (FMEA) templates, quality templates, contract templates, and/or the like. In some examples, the tribal source 114, the document source 116, the system source 118, the enterprise source 120, and the template source 122 (collectively referred to as different sources 114-122) of the federated knowledge base 104 may be continuously or periodically updated by identifying new items. Hereinafter, the items stored in the different sources 114-122 of the federated knowledge base 104 may be referred to as stored items.

In some examples, the stored items may include structured data (e.g., extensible markup language (XML), etc.) and/or unstructured data (e.g., a memo). In some examples, the stored items may include multi-modal inputs, which are associated with multi-modal input formats or different media types. Examples of the multi-modal input formats may include, but are not limited to, text, images, videos, audio, word documents, Portable Document Format (PDF) documents, notes, presentations, spreadsheets, brochure, system logs, screen recording data, and/or the like. Such a multi-modal input support ensures that the document generator 102 is versatile and adaptable to diverse data sources.

In some examples, each of the stored items may provide contents/information/features for events. The events may indicate processes, steps involved in each of the processes, actions performed for accomplishing each of the steps, and/or the like. For example, the events may include, but are not limited to, opening a tool, clicking a submit button, configuring actions for the steps, and/or the like. To illustrate further, consider a domain includes enterprise operations. In such a case, the stored items may provide features for the events such as processes employed in the respective enterprise, detailed steps of each process, actions to accomplish the steps, and/or the like. Alternatively, or additionally, the stored items may provide features such as timestamps for the events. Therefore, one or more portions of the stored items may have temporal content.

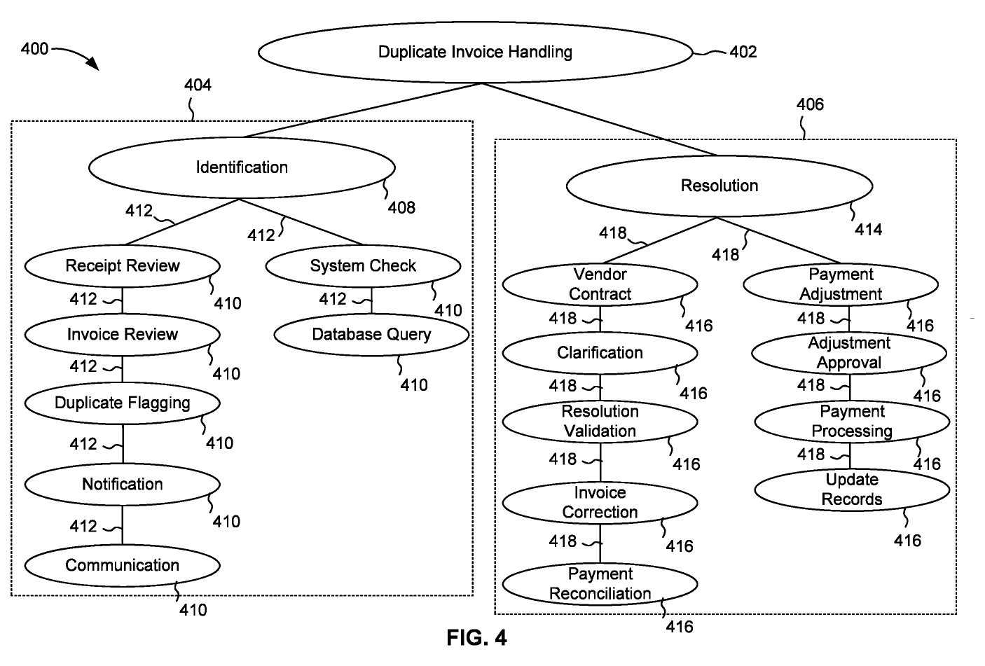

The graph database 106 may include knowledge graphs that are modeled for the stored items. A knowledge graph may include nodes and edges between the nodes. The nodes may represent semantic concepts/content extracted from the stored items and the edges represent relationships between the semantic concepts. An example knowledge graph is illustrated in FIG. 4.

The model database 108 includes Large Language Models (LLMs) 124 (also be referred to as Generative Artificial Intelligence (GAI) models, foundation models, and/or the like). The LLMs 124 may be general-purpose GAI models including large deep learning neural networks trained using a broad range of generalized and unlabeled training data to perform one or more tasks, such as, manual/human computer interactions (e.g., question and answering), automating process execution, process planning, generating step-by-step procedures for the process execution, performing data analysis, and/or the like. In some examples, the LLMs 124 may include pre-trained LLMs to perform functions according to the present disclosure. While implementations of the present disclosure are described in further detail herein with non-limiting reference to the LLMs 124, it is contemplated that implementations of the present disclosure may be realized using any appropriate foundation models or Machine Learning (ML) models, or Artificial Intelligence (AI) models.

The user device 110 may be associated with a user, an Information Technology (IT) administrator, and/or an enterprise/entity (e.g., an organization, a healthcare industry, a legal firm, a retail industry, and/or the like). In some examples, the user device 110 may include a desktop, smartphones, laptops, a tablet, a wearable device, and/or the like. The user device 110 may present one or more user interfaces (e.g., Graphical User Interfaces (GUIs)) of a workspace for the user to interact with the document generator 102 for generating the document.

In some examples, the document generator 102 may be implemented as an on-premises system that is operated by the enterprise or a third-party engaged in cross-platform interactions and items management. In some other examples, the document generator 102 may be implemented as an off-premises system (for example, cloud or on-demand) that is operated by the enterprise or a third-party on behalf of the enterprise. In some other examples, the document generator 102 may be implemented in a cloud environment that is intended to represent various forms of servers including a web server, an application server, a proxy server, a network server, a server pool, and/or the like. In some other examples, the document generator 102 may include a computing device.

In some examples, the document generator 102 may be implemented by way of a single device or a combination of multiple devices that may be operatively connected or networked together. The document generator 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, or other suitable software structures operating in one or more software applications.

Still referring to FIG. 1, the document generator 102 includes a processor 126 and a memory 128 communicably coupled to the processor 126. The processor 126 may include one or more processors. Examples of the processor 126 may include, but are not limited to, microprocessors, microcomputers, microcontrollers, digital signal processors, central processing units, state machines, logic circuits, and/or any devices that manipulate data or signals based on operational instructions. Among other capabilities, the processor 126 may fetch instructions (also be referenced to as processor-executable instructions or machine-executable instructions) from the memory 128 and execute the fetched instructions for performing operations according to the present disclosure. The memory 128 may be non-volatile or non-transitory computer-readable medium (CRM) such as, a magnetic disk or solid-state non-volatile memory or volatile medium such as Random Access Memory (RAM), and/or the like. Further, the document generator 102 includes a document generation manager 130. The document generation manager 130 may be stored in the memory 128 and provided as a downloadable library including the instructions. The document generation manager 130 includes an interface engine 132, a structure generation engine 134, and a document generation engine 136.

In an example implementation, the processor 126 may execute the interface engine 132 to receive an input. In some examples, the input may be received from the user device 110 for generating the document. In some other examples, the input may be received from one or more applications that have been executed on a system of the enterprise. The input may include one or more parameters such as a document type, a purpose, and a description.

In an example implementation, the processor 126 may execute the structure generation engine 134 to generate an output structure for the document. The output structure may include a format or a skeleton or a template of the document, while indicating content items to be present in the document. In some examples, the output structure for the document may be generated by extracting a knowledge graph from the graph database 106 based on the input and processing the knowledge graph using a first LLM from the LLMs 124 stored in the model database 108.

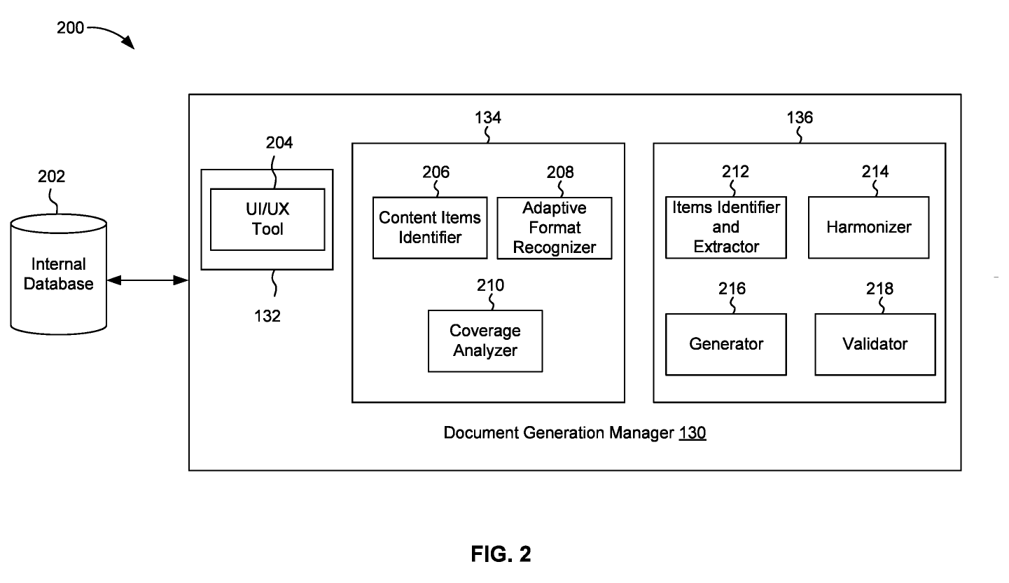

In an example implementation, the processor 126 may execute the document generation engine 136 to generate the document. The document may be generated by (i) identifying and extracting the stored items from the different sources 114-122 of the federated knowledge base 104 based on the output structure generated for the document; (ii) correlating and normalizing the extracted stored items; and (iii) processing the correlated and normalized stored items and the output structure using a second LLM from the LLMs 124 stored in the model database 108. Various examples depicting generation of the document is described in detail in conjunction with FIGS. 2-8.

FIG. 2 depicts an example conceptual block diagram 200 of the document generation manager 130 of the document generator 102 for generating the document, in accordance with implementations of the present disclosure. In some examples, as depicted in FIG. 2, the document generation manager 130 may be communicably coupled with an internal database 202. The internal database 202 may store various data and intermediate results generated by the interface engine 132, the structure generation engine 134, and the document generation engine 136.

The interface engine 132 includes a User Interface/User Experience (UI/UX) tool 204. The UI/UX tool 204 may receive the input for generating the document. In some examples, the UI/UX tool 204 may receive the input from the user device 110 (as depicted in FIG. 1). The UI/UX tool 204 may provide one or more interfaces of applications (including a chatbot) that may be executed on the user device 110 to receive the input. In some examples, the UI/UX tool 204 may receive the input from any of one or more applications being executed on other systems of the enterprise. Examples of the one or more applications may include, but are not limited to, automation applications, agent assistant search applications, training or coaching applications related to customer services, and/or the like.

The input may include one or more parameters such as a document type, a purpose, and a description. While implementations of the present disclosure are described in further detail herein with non-limiting reference to the one or more parameters as the document type, the purpose, and the description, it is contemplated that implementations of the present disclosure may be realized by customizing and using the one or more parameters to address different domains/industries (e.g., different use cases/applications). Customization of the one or more parameters may improve flexibility or versatility of the document generator 102, as the document generator 102 may be used for the different domains/industries. The document type may identify a multi-modal output format for the document and a type of the document. For example, the multi-modal output format may include, but is not limited to, text, a document file, an image, a video, audio, a presentation file, a PDF file, a spreadsheet, or a combination thereof. The type of the document may indicate, but is not limited to, a collaborative platform document (e.g., Wikipedia), a requirement document, a design document, a process document, a contract document, a SOP document, a process map, or a combination thereof. The purpose may indicate what kind of content/content items to be present in the document. For example, the content may indicate high-level description and the detailed section level descriptions related to be process maps, SOPs, and requirements. The description may indicate an objective of the document, for example, how the document is used and who will be using the document. For example, the description may indicate one or more of: a target usage, a consumer associated with the target usage, and a consumption mode associated with the target usage. The UI/UX tool 204 may store the input in the internal database 202 and/or provide the input to the structure generation engine 134.

As depicted in FIG. 2, the structure generation engine 134 includes a content items identifier 206, an adaptive format recognizer 208, and a coverage analyzer 210.

The content items identifier 206 may identify content items to be included in the document, based on the input. The content items may vary based on the document type included in the input and may be relevant to the purpose included in the input. For example, if the input indicates the document type as a document file with a majority of text content, the content items may include sections, block contents, paragraphs, lists, tables, and/or the like. In another example, if the input indicates the document type as a document file with a majority of text content, the content items may include pages, tables, and/or the like. In yet another example, if the input indicates the document type as combination of different media types (e.g., text, video files, audio files, and/or the like), the content items may include pages. Each page may include different media types. For yet another example, if the input indicates the document type as a spreadsheet, the content items may include a number of pages, a number of rows and a number of columns. In yet another example, the content items may include logical block information.

For identifying the content items, the content items identifier 206 may extract a relevant knowledge graph for the input from the graph database 106 (depicted in FIG. 1). In some examples, the relevant knowledge graph may be extracted based on the purpose and the description included in the input. The relevant knowledge graph includes a domain knowledge corresponding to the purpose and the description of the input. The domain knowledge may be associated with information (e.g., semantic concepts/key concepts, detailed description of each concept, and/or the like) in a structured form and/or an unstructured form. In some examples, the knowledge graph may include one or more sub-graphs corresponding to one or more semantic concepts. Each knowledge graph/sub-graph may include nodes representing semantic concepts related to the purpose and edges representing relationships between the semantic concepts. Upon extracting the relevant knowledge graph, the content items identifier 206 may use the knowledge graph and/or one or more sub-graphs from the knowledge graph to identify aspects. The aspects may represent steps involved in processes, process maps, tools used, design steps of product/tool, and/or the like. Based on the identified aspects, the content items identifier 206 may identify the content items to be included in the document. In some examples, the content items may also indicate multi-modal output formats (e.g., videos, audio, text, images, documents, PDFs, presentations, spreadsheets, and/or the like) for the document.

For example, consider a scenario where the received input indicates a document type as a process document with text, and a purpose referencing content related to a “process A”. In such a scenario, the content items identifier 206 may extract a knowledge graph related to the “process A” from the graph database 106 and identify two sub-graphs in the knowledge graph corresponding to the semantic concepts of the “process A” such as “tools used” and “process details”. The content items identifier 206 may process the two sub-graphs, identify steps (e.g., the aspects) to perform the “process A” and accordingly identify content items to be included in a process document of the “process A”. The content items may include sections for each of the identified steps/aspects to perform the “process A”.

Based on the identified content items, the adaptive format recognizer 208 may generate the output structure for the document. In some examples, the adaptive format recognizer 208 may use the first LLM from the LLMs 124 (depicted in FIG. 1) for generating the output structure. For generating the output structure, the adaptive format recognizer 208 may create a sequence of structure generation prompts, based on the identified content items. The adaptive format recognizer 208 may provide the sequence of structure generation prompts along with the content items to the first LLM and obtain the output structure for the document from the first LLM. The first LLM may be pre-trained or configured to query the knowledge graph based on the sequence of structure generation prompts and the content items for generating the output structure.

The output structure may include an ordered hierarchical structure of the content items. For example, if the identified content items include sections, the output structure may indicate which section has to come under which other section like “tools used” under “process details” and sub-sections for each section. To illustrate further, if the input indicates the document type as a document file with a majority of text content, the ordered hierarchical structure of the content items may indicate sections followed by block contents. Each block content may be followed by paragraphs, lists, tables, and/or the like. In another example, if the input indicates the document type as a document file with a majority of text content, the ordered hierarchical structure of the content items may indicate pages followed by tables. In yet another example, if the input indicates the document type as combination of different media types (e.g., text, video files, audio files, and/or the like), the ordered hierarchical structure of the content items may indicate different pages in a sequential order corresponding to the different media types. In yet another example, if the input indicates the document type as a spreadsheet, the ordered hierarchical structure of the content items may indicate a number of pages, each page may include a number of rows and a number of columns. The adaptive format recognizer 208 may provide the output structure generated for the document to the coverage analyzer 210.

The coverage analyzer 210 may verify whether all the content items of the document are included in the output structure. The coverage analyzer 210 may obtain the document templates from the template source 122. Based on the obtained document templates and the input, the coverage analyzer 210 may process the output structure and verify whether all the content items are included in the output structure. When it has been verified that all the content items are not included in the output structure, the coverage analyzer 210 may iteratively perform steps of enabling the content items identifier 206 to identify child/additional content items, enabling the adaptive format recognizer 208 to regenerate the output structure based on the child/additional content items, and verifying whether all the content items are included in the output structure, until verifying that all the content items are included in the output structure. The coverage analyzer 210 may track the content items included in the output structure of the document during each iteration, thereby monitoring coverage of the document to be generated. When it has been verified that all the content items are included in the output structure, the coverage analyzer 210 may store the output structure in the internal database 202 and/or provide the output structure to the document generation engine 136.

As depicted in FIG. 2, the document generation engine 136 includes an items identifier and extractor 212, a harmonizer 214, a generator 216, and a validator 218.

The items identifier and extractor 212 may identify the stored items for the content items of the output structure generated for the document. The items identifier and extractor 212 may determine the stored items available for the content items using by way of non-limiting examples such as, summarization techniques, NLP techniques, and/or the like. The items identifier and extractor 212 may further determine the different sources 114-122 of the federated knowledge base 104 corresponding to the available stored items. Upon determining the different sources 114-122, the items identifier and extractor 212 may derive relationships between the different sources 114-122 and determine roles or contributions of the different sources 114-122 in generating the document. Based on the relationships and roles, the items identifier and extractor 212 may identify one or more of the different sources 114-122 and the corresponding stored items for the content items of the output structure. In some examples, the items identifier and extractor 212 may use one of the LLMs 124 for identifying the one or more of the different sources 114-122 and the corresponding stored items for the content items of the output structure. In some examples, if the stored items are not available for the content items of the output structure, the items identifier and extractor 212 may obtain items from external sources available on the Internet. Therefore, the items identifier and extractor 212 may map inputs (e.g., the content items) with outputs (e.g., the identified stored items) for the document to be generated.

Once the one or more of the different sources 114-122 and the stored items are identified, the items identifier and extractor 212 may extract the stored items from the identified one or more of the different sources 114-122. By way of non-limiting example, the items identifier and extractor 212 may extract the stored items using data mining techniques such as text to SPARQL Protocol and RDF Query Language (SPARQL), text to Structured Query Language (SQL), enterprise textual search, and/or the like. At least a portion of the extracted stored items may include a temporal content. The temporal content may refer to time information or timestamps associated with the events (e.g., indicating processes, steps involved in each of the processes, actions performed for accomplishing each of the steps, and/or the like). In some examples, the stored items extracted from the respective one or more of the different sources 114-122 may be in their raw form. The items identifier and extractor 212 may store the extracted stored items in the internal database 202 and/or provide the stored items to the harmonizer 214.

The harmonizer 214 may identify a first portion of the extracted stored items (from the one or more of the different sources 114-122) having a temporal relationship and a second portion of the stored items that lacks a temporal relationship. Each of the first portion and the second portion may include stored items associated with the multi-modal input formats such as video files, audio files, text, system logs, screenshots, transcripts, document files, PDF files, images, and/or the like. The first portion having the temporal relationship may include the stored items having inter-propositional relation that communicates simultaneity or ordering of the events in time. Each stored item within the first portion may have a timestamp/duration based on frames that are presented at discrete times or events identified in a structured format with each event including a timestamp. For example, a first stored item of the first portion may have a first timestamp for an event that is being occurring in a second stored item of the first portion. The second stored item of the first portion may have a second timestamp for the same event. To illustrate further, the first portion may include first and second stored items such as a video and a screenshot recording capturing an “event A” of the events (e.g., clicking on initialization button, searching an invoice, submitting the invoice, a process for accessing design details of a product, and/or the like). Further, the video and the screenshot recording may include a first timestamp, and a second timestamp for the “event A” in different chronological orders. The first timestamp may be after the second timestamp of the “event A” included in the screenshot recording. The second portion of the stored items that lack the temporal relationship may include the stored items/contents having an unstructured output form or a structured format without a timestamp.

Upon identifying the first portion and the second portion of the stored items, the harmonizer 214 may extract first features from the stored items of the first portion and second features from the stored items of the second portion. In some examples, for extracting the features (including the first features and the second features), the harmonizer 214 may identify timeline information or a timestamp of each source of the different sources 114-122 that includes the first portion and the second portion of the stored items and use the timeline information to map contents from the different sources 114-122. Further, the harmonizer 214 may use content similarities between the contents and a context associated with each content to identify and map the features, which are similar or relative to each other. The harmonizer 214 may extract the mapped features from the respective different sources 114-122 by addressing limitations involved in identifying and mapping the same events across the different sources 114-122. The extracted features may provide complete information of the event. As would be understood, the features may include the contents that describe the events. In some examples, extracting the first features from a stored item of the first portion may include extracting a first mode of content from the stored item based on a time domain analysis and extracting a second mode of content from the stored items based on a frequency domain analysis. In some examples, the first mode of content may include an optical flow over time and the second mode of content may include text converted from speech. By way of non-limiting example, if the stored item of the first portion includes a video, the extracted first mode of content may include images and the extracted second mode of content may include a transcript.

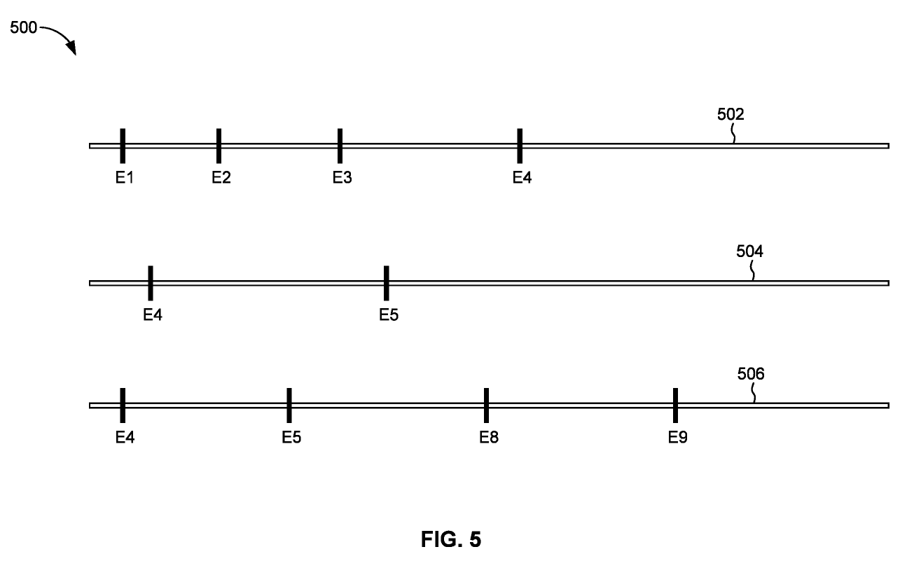

After extracting the first features from the stored items of the first portion, the harmonizer 214 may identify correlated features of the first portion. The correlated features may be identified based on evaluation of the first features extracted from the stored items of the first portion. In some examples, the harmonizer 214 may apply a cross-attention mechanism on the first features to retrieve natural language content associated with each of the first features and perform evaluation to determine how each of the first features are correlated to other features of the first features based on respective natural language contents. The cross-attention mechanism may involve assigning an attention weight or a weight coefficient for each of the first features. The attention weight of each of the first features may be used to generate a context vector that captures the natural language content associated with each of the first features. Based on the performed evaluation, the harmonizer 214 may identify the correlated features of the first portion. For example, the harmonizer 214 may identify that a feature among the first features corresponding to a first correlated event in the first stored item of the first portion is correlated to another feature among the first features corresponding to a second correlated event in the second item of the first portion. An example illustration of identifying the correlated features is depicted in FIG. 5.

Once the correlated features of the first portion are identified, the harmonizer 214 may normalize the correlated features, thereby forming meaningful knowledge to generate the document. Normalizing the correlated features may include updating timestamps of the correlated features equivalent to the output structure of the document. For example, a first timestamp of a feature and a second timestamp of its correlated feature may be updated to be equivalent with respect to the output structure of the document. In some examples, the harmonizer 214 may use any of the LLMs 124 for normalizing the correlated features. Such a normalization may ensure coherence and temporal alignment of the stored items or features, enabling generation of the contextually relevant document. After normalizing, the harmonizer 214 may provide the first features to the generator 216.

The generator 216 may generate the document based on the first features (correlated and normalized features), the second features, and the output structure of the document. The generator 216 may use the second LLM from the LLMs 124 for generating the document. In some examples, for generating the document, the generator 216 may generate or synthesize a sequence of document generation prompts for the second LLM based on the output structure. The generator 216 may identify the content items in the output structure and obtain the associated knowledge graph from the graph database 106. Based on the identified content items and associated knowledge graph, the generator 216 may generate the sequence of document generation prompts. The generator 216 may execute the sequence of document generation prompts, which may prompt the second LLM to generate the document.

In some examples, the sequence of document generation prompts may be executed according to the first features (that have been correlated and normalized), the second features and the content items of the output structure. For example, the generator 216 may provide a first prompt of the sequence of document generation prompts including a first content item from the content items of the output structure and the first features and the second features to the second LLM and receive a first response. The first response may indicate integration of features (including the first features and/or the second features) of the stored items for the first content item. Upon receiving the first response, the generator 216 may generate a second prompt of the sequence of document generation prompts based on the first response and a second content item that follows the first content item in a sequence. The generator 216 may provide a second prompt along with the second content item, and the features of the first portion and the second features to the second LLM and receive a second response. The second response may indicate integration of features (including the first features and/or the second features) of the stored items for the second content item. Similarly, the generator 216 may iteratively perform steps of generating subsequent prompts (e.g., a third prompt, a fourth prompt, and/or the like) based on a previous response and a subsequent content item in the output structure, prompting the second LLM using the subsequent prompts, and receiving subsequent responses from the second LLM, until receiving responses for all the content items in the output structure. Thereby, the document may be generated by including the responses/the features extracted from the first and/or second portions of the stored items for all the content items in the output structure. The generated document may include dynamically identified one or more portions (e.g., the features) of the stored items for each of the content items of the output structure, which may improve speed of generating the document.

The validator 218 may validate the generated document to check adherence of the document. The validator 218 may validate the generated document by performing evaluation of the features (including the first features (correlated and normalized features) and/or the second features) of the stored items included for the respective content items. The validator 218 may perform evaluation of the features based on quality control checks, security and compliance checks, completeness checks, and/or the like. In some examples, the evaluation performed based on the quality control checks may include evaluation of the features of the stored items based on grammar, language used, translation quality, and/or the like. In some examples, the evaluation performed based on the completeness checks may involve leveraging the second LLM to process the input or the description in the input and compare the processed input/description with respect to the content items and the respective stored items in the document. To illustrate further, the evaluation performed based on the completeness checks may involve determining whether a continuity is present in the content items and/or the respective features of the stored items, whether restructuring or reframing is required in the content items and/or the respective features of the stored items, whether the features of the stored items included for the respective content items are relevant, and/or the like. In some examples, the evaluation performed based on the security and compliance checks may include determining whether any of the features of the stored items include sensitive data or the features of the stored items are against data privacy. If the features of the stored items include sensitive data or against the data privacy, then such features may be removed from the document.

Based upon the evaluation, the validator 218 may generate confidence scores for the content items. If the confidence scores of the content items satisfy a predetermined threshold, the validator 218 may determine that the generated document is valid, thereby resulting in successful validation. If any of the confidence scores fail to satisfy the predetermined threshold, the validator 218 may determine that the generated document is not valid and enable regeneration of the document, thereby resulting in unsuccessful validation. In some examples, the document may be regenerated by identifying new features of the stored items for the one or more content items associated with the confidence scores that fail to satisfy the predetermined threshold to improve accuracy and quality of the document. Additionally, or alternatively, the validator 218 may provide the generated document along with the confidence scores generated for the content items to human validators for further validation.

In some examples, based upon the successful validation, the validator 218 may provide the document to the user of the user device 110 from which the input has been received. In some other examples, based upon the successful validation, the validator 218 may provide the document to the one or more applications being executed on other systems of the enterprise from which the input has been received. The one or more applications may utilize the document to perform one or more respective tasks by leveraging GAI models. The one or more tasks may include automating codes, performing agent-assisted searches (e.g., search for questions and answers, browse FAQs, summaries, and/or the like), providing a training to appropriate teams of the enterprise (e.g., simulated training, coaching, conducting quiz/tests, and/or the like), and so on. The one or more applications may receive feedback from the one or more respective tasks and provide the feedback to the document generator 102. The feedback may indicate the quality of the document, one or more checks such as the quality control checks, completeness checks, and security and compliance checks to further improve the quality of the document. The document generator 102 may use such feedback to generate the document in further iterations, which may improve performance of the document generator 102 in generating the document as well as the quality of the document.

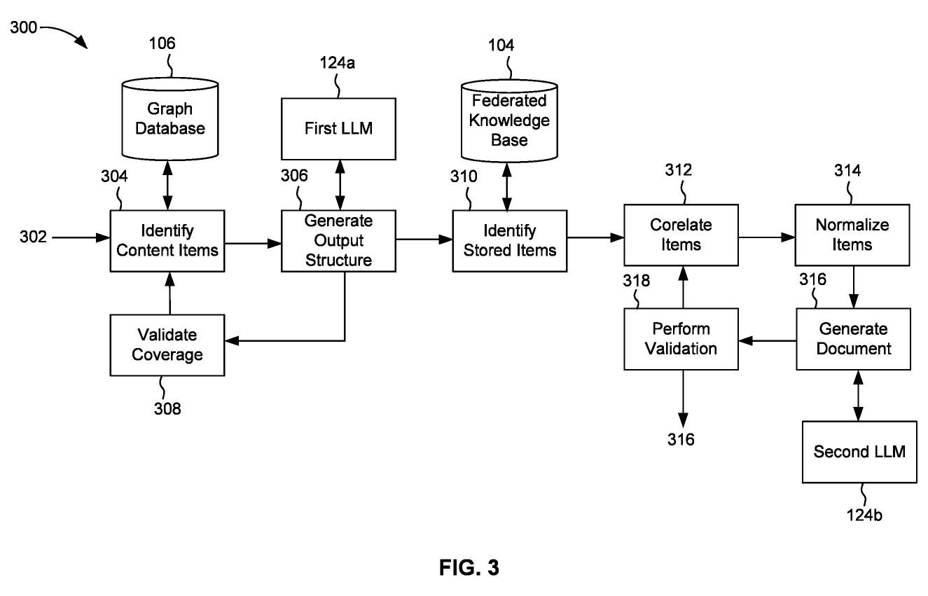

FIG. 3 depicts an example process flow 300 of generating the document, in accordance with implementations of the present disclosure. Implementations of the present disclosure are described in FIG. 3 by considering an example use case of generating a process document for a duplicate invoice handling process, however, as would be understood other similar use cases may be considered. The process flow 300 may be implemented using the document generator 102 as described in relation to FIGS. 1-2.

The document generator 102 receives an input 302 for generating a process document 316. In some examples, the document generator 102 may receive the input 302 from the user device 110 (depicted in FIG. 1). For example, the input 302 may include:

Document Type: Process document including video files

Purpose: Detailed sections describing end to end procedure of the duplicate invoice handling process

Based on the input 302, the document generator 102 identifies content items 304. The content items 304 may indicate required components of the process document 316. For identifying the content items 304, the document generator 102 may obtain a knowledge graph related to the duplicate invoice handling process from the graph database 106. An example knowledge graph 400 related to the duplicate invoice handling process is depicted in FIG. 4. As depicted in FIG. 4, the knowledge graph 400 includes a main node 402 indicating the duplicate invoice handling process. The knowledge graph 400 is illustrated as a hierarchical unidirectional graph, but the knowledge graph can include edges between any node that define a relationship between nodes. From the main node 402, sub-graphs 404 and 406 may be formed. The sub-graphs 404 and 406 may correspond to main steps of the duplicate invoice handling process such as an identification process and a resolution process, respectively. A sub-graph 404 may include a main node 408 indicating the identification process. The main node 408 may include sub-nodes 410 indicating semantic concepts corresponding to detailed steps of the identification process and edges 412 indicating relationships between the sub-nodes 410. A sub-graph 406 may include a main node 414 indicating the resolution process. The main node 414 may include sub-nodes 416 indicating semantic concepts corresponding to detailed steps of the resolution process and edges 418 indicating relationships between the sub-nodes 416. Upon extracting the knowledge graph 400, the document generator 102 may identify and evaluate the sub-graphs 404 and 406. Based on evaluation of the sub-graphs 404 and 406, the document generator 102 may determine the aspects such as steps involved in the duplicate invoice handling process. The steps may include mandatory and/or optional steps. In an example herein, the steps involved in the duplicate invoice handling process may be identified as:
i For a given invoice number, search for an invoice name in an information search tool (e.g., ERP tool) to find if there is any other invoice with same name;
ii Check if the date, amount and names are same across invoices, if another invoice found;
iii Mark one of the invoices duplicate in the information search tool; and
iv Update the status of a respective invoice number as "duplicate"

Upon identifying the steps, the content items identifier 206 may determine the content items 304 to be included in the process document. For example, the content items 304 may indicate sections, and sub-sections related to the steps identified for the duplicate invoice handling process.

Referring back to FIG. 3, once the content items 304 are identified, the document generator 102 generates an output structure 306 for the process document 316. For generating the output structure 306, the document generator 102 may generate a sequence of structure generation prompts. The sequence of structure generation prompts may be generated based on specific prompt patterns related to the duplicate invoice handling process. For example, the sequence of structure generation prompts may include:

Actionability: Prompts that identify actions like opening tool, click button, and/or the like.

Explainability: Prompts to describe the steps and explain why certain actions are taken in each of the steps.

Specificity: Prompts to extract specific information about the steps, a process code, a T-code, and/or the like.

The document generator 102 may provide the sequence of structure generation prompts along with the identified content items 304 to a first LLM 124a from the LLMs 124 stored in the model database 108 (depicted in FIG. 1) and obtain the output structure 306 from the first LLM 124a. The output structure 306 may indicate an ordered hierarchical structure of the content items 304. For example, the ordered hierarchical structure of the content items 304 may include hierarchical ordering of sections. Further, each section may include one or more block contents. Each block content may include a paragraph, a list, or a table.

Once the output structure 306 is generated, the document generator 102 validates coverage 308 of the content items 304 in the output structure 306. For example, the document generator 102 may validate the coverage 308 by evaluating whether the content items 304 included in the output structure 306 satisfy various factors such as accessibility, explainability, specificity, completeness, and/or the like. The various factors may be derived from the document templates, which are predefined and stored in the template source 122. When it has been evaluated that the content items 304 included in the output structure 306 satisfy the various factors, the document generator 102 may determine to use the output structure 306 for generating the document, thereby determining the coverage 308 is valid. When it has been evaluated that the content items 304 included in the output structure 306 does not satisfy any of the various factors, the document generator 102 may determine that the coverage 308 is not valid and iteratively reperforms identification of the content items 304 and generation of the output structure 306, until the coverage 308 of the content items 304 in the output structure is valid.

When it has been validated that the coverage 308 is valid, the document generator 102 identifies stored items 310 for the content items of the output structure 306. For example, the document generator 102 may identify the stored items 310 for the sections, the one or more block contents, paragraphs, lists, tables, and/or the like.

For identifying the stored items 310, the document generator 102 may identify a set of stored items available for the invoice duplicate handling process and the corresponding different sources 114-122 (depicted in FIG. 1) of the federated knowledge base 104. The document generator 102 may analyze relationships between the identified different sources 114-122 and a role of each source in generating the process document. Based on the analysis, the document generator 102 may select one or more of the different sources 114-122 and accordingly identify the stored items 310 from the set of stored items for each of the content items 304 of the output structure. The stored items 310 may be associated with the multi-modal output formats as indicated by the respective content items 304 of the output structure 306. For example, for a content item/section corresponding to a step of “searching an invoice number using the ERP tool”, the document generator 102 may identify the stored items 310 associated with the different formats such as a video, a system log, a screen recording/screenshot, and an image, from the identified one or more of the different sources 114-122. By way of non-liming example, a stored item associated with the video may indicate how to search with an invoice number and obtain an invoice name from a home page using the ERP tool. A stored item associated with the system log may include action logs indicating actions to search with the invoice number in the ERP tool and indicating a specific process of accessing a Uniform Resource Locator (URL) like “xyz.com” to search with an invoice number by inputting the invoice number in a search box and click on a search button. A stored item associated with the screen recording may provide an image specific to search with the invoice number in the ERP tool. A stored item associated with the image may provide an ERP tool image.

Once the stored items 310 are identified for each of the content items 304, the document generator 102 may extract features from the stored items 310 and identify correlated features as correlated items 312. For identifying the correlated items 312, the document generator 102 identifies a first portion and a second portion of the stored items 310. The first portion may have the temporal relationship, and the second portion may lack the temporal relationship. For example, the first portion may include the stored items associated with the formats such as the video, the action log, and the screen recording and may provide timestamps of the events. The second portion may include the stored items associated with the image, without including any timestamp. In some examples, the document generator 102 may perform a temporal validation on the first portion and the second portion to determine whether the first portion and second portion are appropriately identified from the stored items 310. For example, the document generator 102 may perform the temporal validation to determine whether the first portion includes the contents having the temporal relationship. If the first portion does not include the contents having the temporal relationship, the document generator 102 may identify that the first portion is not appropriately identified from the stored items 310. If the first portion and the second portion are not appropriately identified from the stored items, the document generator 102 may reiterate the step of identifying the first portion and the second portion from the stored items 310. If the first portion and the second portion are appropriately identified from the stored items 310, the document generator 102 may use the identified first portion and second portion for further use. In some examples, the document generator 102 may use temporal properties (e.g., timestamps) associated with the stored items 310 to perform the temporal validation. The temporal validation may ensure that the stored items 310 are appropriately or properly categorized based on their temporal properties. Once the first portion and the second portion are appropriately identified from the stored items 310, the document generator 102 may extract features/contents from the first portion of the stored items 310 and features/contents from the second portion of the stored items 310.

Upon extracting the features from the first portion of the stored items 310, the document generator 102 identifies, from the extracted features, the correlated features/correlated items 312. An example illustration 500 of identifying the correlated items 312 from the first portion of the stored items 310 is depicted in FIG. 5. As depicted in FIG. 5, consider a scenario where the first portion of the stored items 310 include a stored item 502, a stored item 504, and a stored item 506 having the temporal relationship for one of the content items 304. The stored item 502, the stored item 504, and the stored item 506 may be extracted from the one or more of the different sources 114-122 of the federated knowledge base 104. The stored item 502 may be in a form of video (e.g., video format) including video frames describing different events such as E1, E2, E3, and E4 along with timestamps. The stored item 504 may in the form of system log including multiple action logs in sequence describing different events such as E4 and E5 along with timestamps. The stored item 506 may be in the form of screen recording including multiple images describing different events such as E4, E6, E7, and E8 along with timestamps. In such a scenario, the document generator 102 may extract features/contents from the stored item 502, the stored item 504, and the stored item 506 corresponding to the different events. Among the extracted features, the document generator 102 may identify features from the stored item 502, the stored item 504, and the stored item 506 corresponding to the event E4 are mutually exclusive. Accordingly, the document generator 102 may identify such mutually exclusive features as the correlated items 312 for the event E4. Among the correlated features/correlated items 312, a feature from the stored item 502 may describe the event E4 with a first timestamp, a feature from the stored item 504 may describe the event E4 with a second timestamp, and a feature from the stored item 506 may describe the event E4 with a third timestamp. The first timestamp, the second timestamp, and the third timestamp may be in a different chronological order.

In addition, among the extracted features from the stored item 502, the stored item 504, and the stored item 506 corresponding to the different events, the document generator 102 may identify features from the stored item 504 and the stored item 506 corresponding to the event E5 are mutually exclusive. Accordingly, the document generator 102 may identify such mutually exclusive features as the correlated items 312 for the event E5. Among the correlated items 312, a feature from the stored item 504 may describe the event E5 with a first timestamp and a feature from the stored item 506 may describe the event E5 with a second timestamp. The first timestamp and the second timestamp may be in a different chronological order.

Referring back to FIG. 3, upon identifying the correlated items 312, the document generator 102 normalizes the correlated items 312, thereby generating normalized items 314. The document generator 102 may generate the normalized items 314 by mapping and updating the timestamps of the correlated items 312 to be equivalent with respect to the output structure 306. For example, with reference to the example depicted in FIG. 5, the correlated items 312 identified from the stored item 502, the stored item 504, and the stored item 506 for the event E4 may be mapped and the corresponding first timestamp, second timestamp, and third timestamp may be updated to be equivalent with respect to the output structure. For another example, with reference to the example depicted in FIG. 5, the correlated items 312 identified from the stored item 504 and the stored item 506 for the event E5 may be mapped and the corresponding first timestamp and second timestamp may be updated to be equivalent with respect to the output structure. Implementations of the present disclosure enable identifying and mapping of the features from the stored items extracted from the different sources 114-122 and normalization of the features across, which may improve the speed of generating the document and ensure data consistency across the different sources 114-122.

After generating the normalized items 314, the document generator 102 generates the process document 316. The document generator 102 may use a second LLM 124b from the LLMs 124 stored in the model database 108 for generating the process document 316. The document generator 102 may generate the sequence of document generation prompts, provide the sequence of document generation prompts to the second LLM 124b and obtain the process document 316.

For example, consider a scenario where the output structure includes content items such a section 1, a section 2, a section 3, and a section 4 corresponding to steps 1-4 of the duplicate invoice handling process. In such a scenario, the document generator 102 may generate a prompt 1 based on the section 1 corresponding to a step 1 of the duplicate invoice handling process. The document generator 102 may provide the prompt 1 along with the normalized items 314 (e.g., corresponding to the event E4 as depicted in FIG. 5) and the second features identified for the section 1 to the second LLM 124b and may obtain, from the second LLM 124b, a response 1 indicating integration of the respective normalized items 314 and/or the second features for the section 1. Thereafter, the document generator 102 may generate a prompt 2 based on the section 2 (following the section 1 in a sequential order) corresponding to a step 2 of the duplicate invoice handling process. The document generator 102 may provide the prompt 2 along with the normalized items 314 (e.g., corresponding to the event E5 as depicted in FIG. 5) and/or the second features identified for the section 2 to the second LLM 124b and may obtain, from the second LLM 124b, a second response indicating integration of the respective normalized items 314 and/or the second features for the section 2. The document generator 102 may generate a prompt 3 based on the section 3 corresponding to a step 3 of the duplicate invoice handling process, provide the prompt 3 along with the normalized items 314 and/or the second features identified for the section 3 to the second LLM 124b, and obtain, from the second LLM 124b. a third response. The third response may indicate integration of the respective normalized items 314 and/or the second features for the section 3. Upon receiving the third response, the document generator 102 may generate a prompt 4 based on the section 4 corresponding to a step 4 of the duplicate invoice handling process, provide the prompt 4 along with the normalized items 314 and/or the second features identified for the section 4 to the second LLM 124b, and obtain, from the second LLM 124b, a fourth response. The fourth response may include the process document 316 generated by integrating the respective normalized items 314 and/or the second features with all the sections 1-4 of the output structure. The generated process document 316 may include the features/contents of the stored items 310, which may be associated with the multi-modal output formats.

After generating the process document 316, the document generator 102 performs validation 318, based on the input 302, to check adherence of the generated process document 316. In some examples, the document generator 102 may perform the validation 318 based on the quality control checks, the security and compliance checks, and the completeness checks (described in detail in conjunction with FIG. 2). Based upon the unsuccessful validation, the document generator 102 may iteratively enable regeneration of the process document 316 until achieving the successful validation. Based upon the successful validation, the document generator 102 may provide the process document 316 to the user of the user device 110 and/or store the process document 316 in the internal database 202.

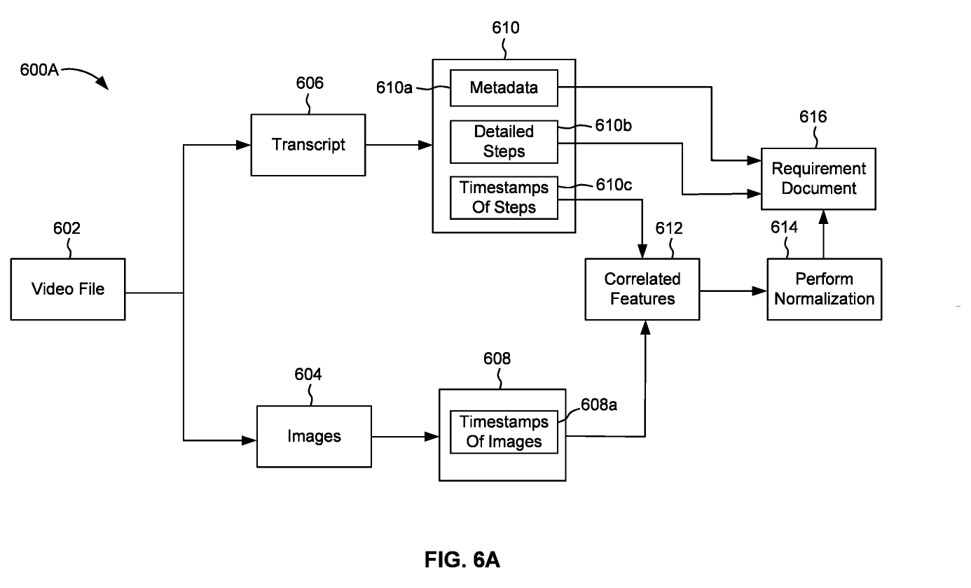

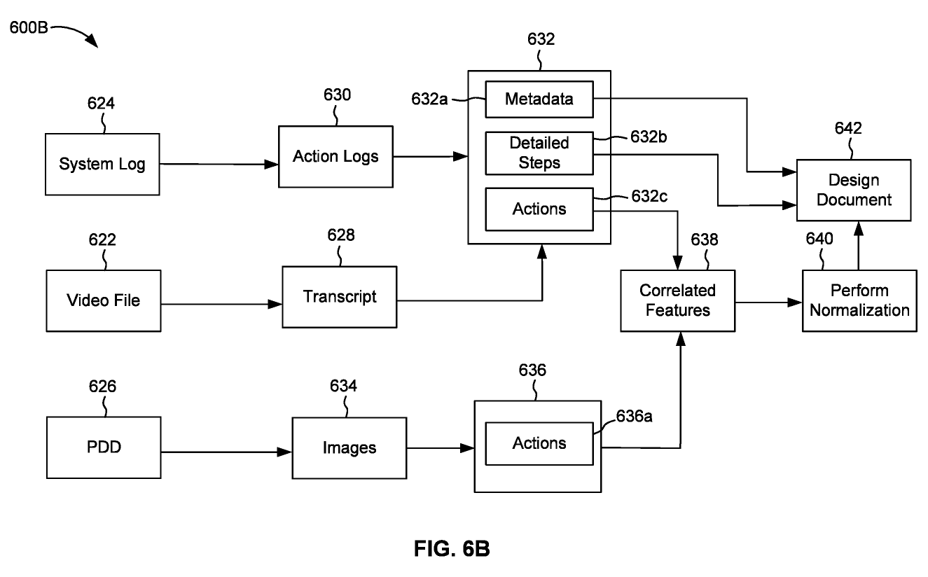

FIG. 6A depicts an example illustration 600A of generating the document, in accordance with implementation of the present disclosure. Consider an example scenario, as depicted in FIG. 6A, where the document generator 102 identifies a stored item like a video file 602 for a content item in an output structure derived for generation of a requirement document 616. The requirement document 616 may report detailed analysis of projects required for success of an enterprise, for example, a summary of the projects, requirements of the projects, scope of the projects, stakeholders associated with the projects, risks associated with the projects, and/or the like. The video file 602 may include a knowledge Transfer (KT) video describing the process involved in the detailed analysis of the projects. Upon identification of the video file 602, the document generator 102 extracts the video file 602 from one of the different sources 114-122 of the federated knowledge base 104.

Upon extracting the video file 602, the document generator 102 extracts images 604 (first mode of content) and transcript 606 (second mode of content) from the video file 602. The images 604 may provide features 608 (e.g., the first features) such as timestamps 608a of the images (e.g., optical flow over time). The transcript 606 may provide features 610 such as: a metadata 610a about a process involved in the detailed analysis of the projects, detailed steps 610b of the process, and timestamps 610c (e.g., the first features) of the detailed steps 610b. Thereby, the transcript 606 may provide text over the speech.

Among the features 608 including the timestamps 608a and the features 610 including the timestamps 610c, the document generator 102 identifies features that are mutually exclusive (e.g., the features describing the same steps) and considers such features as correlated features 612. Further, the document generator 102 maps the identified correlated features 612 by updating the respective timestamps to an equivalent timestamp, thereby performing normalization 614 of the correlated features 612. After normalization 614, the document generator 102 generates the requirement document 616 based on the correlated features 612, other features (the metadata 610a and the detailed steps 610b) of the transcript 606, and the output structure derived for the requirement document 616.

FIG. 6B depicts another example illustration 600B of generating the document, in accordance with implementation of the present disclosure. Consider an example scenario, as depicted in FIG. 6B, where the document generator 102 identifies stored items such as a video file 622, a system log 624, and a Product Design Document (PDD) 626 for one of the content items in an output structure derived for generation of a design document 642. The document generator 102 may further extract the identified video file 622, the system log 624, and the PDD 626 from the one or more different sources 114-122 of the federated knowledge base 104. The design document 642 may provide information about a process involved in designing or development of a product. The extracted video file 622, system log 624, and PDD 626 may detail the process involved in designing or development of the product.

From the extracted video file 622 and system log 624, the document generator 102 extracts a transcript 628 and action logs 630, respectively. The document generator 102 combines the transcript 628 and the action logs 630 to identify features 632 such as metadata 632a about the process of designing the product, detailed steps 632b of the process, and features describing actions 632c performed for accomplishing each of the steps. Similarly, from the PDD 626, the document generator 102 extracts one or more images 634. The one or more images 634 may indicate features 636 like actions 636a performed for accomplishing each of the steps. Among the features 632 describing the actions 632c and the features 636 describing the actions 636a, the document generator 102 identifies features that are mutually exclusive, for example, the features describing a same action. To illustrate further, the actions 632c and 636a may indicate “clicking on start button to initiate the process”, “clicking on selection button to select a step”, “clicking on finish button to submit”, and/or the like. In such a scenario, the document generator may identity features describing a same action as “clicking on finish button to submit” as mutually exclusive. The document generator 102 considers the features that are mutually exclusive as the correlated features 638 and maps the correlated features 638 by performing normalization 640 of the correlated features 638. After performing the normalization 640, the document generator 102 generates the design document 642 based on the correlated features 638, other features such as the metadata 632a and the detailed steps 632b, and the output structure.

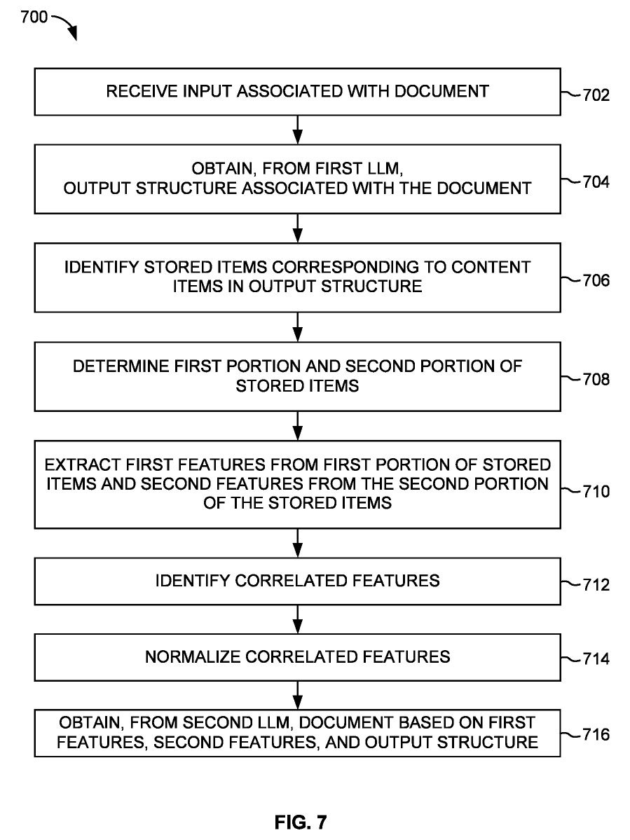

FIG. 7 is a flow diagram that presents an example method 700 for generating a document, in accordance with implementations of the present disclosure. In some implementations, the method 700 may be executed by the processor 126 (including the one or more processors) of the document generator 102, as described in relation to FIGS. 1-5, 6A and 6B.

At block 702, the method 700 includes receiving an input associated with the document to be generated. The input includes one or more parameters including a document type, a purpose, and a description. In some examples, the document type may identify a modal output of the document (e.g., text, video files, audio files, document files, image files, or a combination thereof). The purpose may reference related content including process maps, standard operating procedures, and requirements. The description may identify a target usage, a consumer associated with the target usage, and a consumption mode associated with the target usage.

At block 704, the method 700 includes obtaining from the first LLM 124a (depicted in FIG. 3), an output structure associated with the document. The output structure includes an ordered hierarchical structure of content items based on the document type. In some examples, the content items for the document may be identified using a knowledge graph. The identified content items and the respective knowledge graph may be provided to the first LLM 124a and the output structure may be received from the first LLM 124a. The first LLM 124a may be configured to query the knowledge graph representing a domain knowledge having associated with information in a structured form and an unstructured form. The knowledge graph may include a pointer to the stored items. In some examples, in response to determining the content items are not sufficient for the document, child or new content items may be obtained for the output structure.

The output structure may correspond to the document type. For example, when the document type corresponds to a majority of text content, the output structure may include an ordered hierarchical including different sections. Each section includes at least one block content, and a block content includes a logical section/block of information, a paragraph, a list, or a table. For another example, when the document type corresponds to a majority of array-based content, the ordered hierarchical structure of content items includes pages, and each page includes a table. For yet another example, when the document type corresponds to multiple content types, the ordered hierarchical structure of content items includes a plurality of pages, and each page includes multiple media types.

At block 706, the method 700 includes identifying stored items corresponding to the content items of the output structure. In some examples, the content items include modal output formats. In some example, one or more portions of the stored items include temporal content.

At block 708, the method 700 includes determining a first portion of the stored items having a temporal relationship and a second portion of the stored items that do not have a temporal relationship. The first portion having the temporal relationship may include content having a duration based on a plurality of frames that are presented at discrete times or events identified in a structured format with each event including a timestamp. The second portion that lacks the temporal relationship may include content having an unstructured output form or a structured format without a timestamp.

At block 710, the method 700 includes extracting first features from the first portion of the stored items and second features from the second portion of the stored items. In some examples, extracting the first features from a stored item of the first portion may include extracting a first mode of content from the stored item based on a time domain analysis and extracting a second mode of content from the stored item based on a frequency domain analysis. The first mode of content may include an optical flow over time. The second mode of content may include text converted from speech.

At block 712, the method 700 includes identifying correlated features within the first portion of the stored items using a natural language content associated with the first features. In some examples, a first correlated event in a first stored item of the first portion is identified as being correlated to a second correlated event in a second stored item of the first portion having a different mode than the first stored item. The first stored item may include a first timestamp associated with an event occurring in the second stored item of the first portion. The first timestamp may be after a second timestamp associated with the corresponding event in the second stored item. In some examples, the correlated features may be identified by applying a cross-attention mechanism to the first portion of the stored items to identify the correlated features.

At block 714, the method 700 includes normalizing the correlated features of the first portion in time based on the correlated features. In some examples, normalizing the correlated features may include updating the first timestamp and the second timestamp to be equivalent with respect to the output structure of the document.

After normalizing the correlated features of the first portion, at block 716, the method 700 includes obtaining from the second LLM 124b (depicted in FIG. 3), the document based on the first features, the second features, and the output structure. In some examples, obtaining the document may include (i) providing a first prompt including a first content item of the content items in the ordered hierarchical structure; (ii) receiving a first response in response to the first prompt; (iii) generating a second prompt based on a second content item that follows the first content item in sequence and the first response; (iv) receiving a second response in response to the second prompt; and (v) providing a third prompt to synthesize the first response and the second response. The document is provided in response to the third prompt. In some examples, the generated document may be further validated to check adherence of the document. The generated document may be validated by processing the input or the description in the input using the second LLM 124b.

Implementations of the present disclosure provide technical solutions to provide multiple technical improvements and address drawbacks of existing document generation tools. Implementations of the present disclosure provide an automated and efficient framework to generate the document by integrating and normalizing at least one portion (e.g., first portion) of the stored items present in the different sources of the federated knowledge base in different formats/modes through interaction mechanisms. The interaction mechanism may enable identification of the at least portion of the stored items required for generating the document dynamically or at any given point of time and identifying an appropriate source for extracting the identified at least portion of the stored items. The generation of the document with dynamic identification of the at least one portion of the stored items results in the document with high accuracy, which may further improve speed of generating the document and eliminate a need for manual intervention in editing the generated document. As a result, implementations of the present disclosure may provide efficiencies in terms of technical/computing resources consumption, which also includes minimizing latency (even under heavy loads).

Implementations of the present disclosure enable the automated and efficient document generation framework to automatically improve its performance with each iteration of generating the document. With each iteration, the framework may dynamically learn new input-output mappings and the input-output mappings may be used to efficiently generate the document.

Implementations of the present disclosure may also provide flexibility in integration of the automated and efficient document generation framework into existing workflows and software systems (e.g., CRM systems, ERP systems, and/or the like). This includes, for example, handling structured data and unstructured data and seamless connection with existing databases, file systems, and/or the like, to enable unified processes of generating the document. Implementations of the present disclosure also enhance scalability to scale in response to demand without compromising quality or performance of the document.

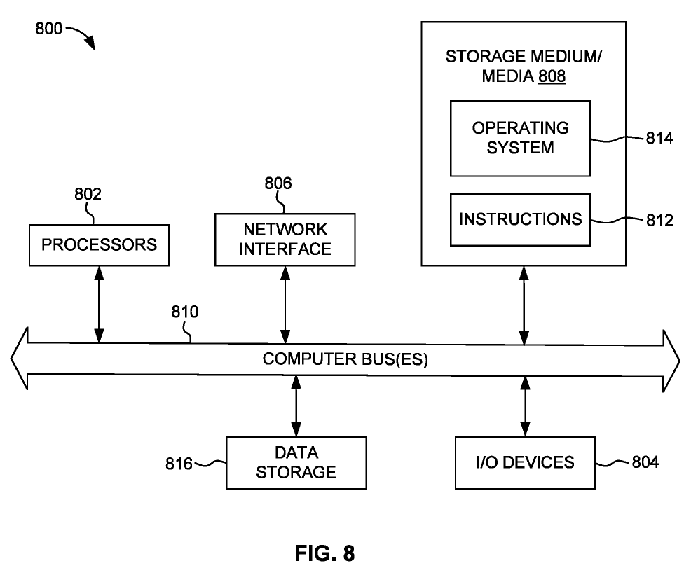

FIG. 8 depicts a computer system 800 that may be used to implement the document generator 102. More particularly, computing machines such as desktops, laptops, smartphones, tablets, and wearables which may be used to generate the document. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802, such as a central processing unit, ASIC or another type of processing circuit, input/output devices 804, such as a display, mouse keyboard, etc., a network interface 806, such as a Local Area Network (LAN), a wireless 802.11x LAN, a 3G or 4G mobile WAN or a WiMax WAN, and a computer-readable medium 808. Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium, such as a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the document generator 102.

The document generator 102 may be implemented as software stored on a non-transitory processor-readable medium and executed by the processor(s) 802. For example, the computer-readable medium 808 may store an operating system 814, such as MAC OS, MS WINDOWS, UNIX, or LINUX, and code, for the document generator 102. The operating system 814 may be multi-user, multiprocessing, multitasking, multithreading, real-time, and the like. For example, during runtime, the operating system 814 is running and the code for the document generator 102 is executed by the processor(s) 802.

The computer system 800 may include a data storage 816, which may include non-volatile data storage. The data storage 816 stores any data used or generated by the document generator 102.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term "computing system" encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes, or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network ("LAN") and a wide area network ("WAN"), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method of generating a document, comprising,
receiving an input associated with the document to be generated, the input including one or more parameters including a document type, a purpose, and a description;
obtaining, from a first Large Language Model (LLM), an output structure associated with the document, the output structure comprising an ordered hierarchical structure of content items based on the document type;
identifying stored items corresponding to the content items of the output structure, wherein the content items indicate a plurality of modal output formats, wherein at least a portion of the stored items include temporal content;
determining a first portion of the stored items having a temporal relationship and a second portion of the stored items that lacks the temporal relationship;
extracting first features from the first portion of the stored items and second features from the second portion of the stored items;
identifying correlated features within the first portion of the stored items using natural language content associated with the first features, wherein a first correlated event in a first stored item of the first portion is identified as being correlated to a second correlated event in a second stored item of the first portion having a different mode than the first stored item;
normalizing the correlated features of the first portion in time based on the correlated features; and
after normalizing the correlated features of the first portion, obtaining, from a second LLM, the document based on the first features, the second features, and the output structure.

2. The method of claim 1, wherein the document type identifies a modal output of the document,
wherein the purpose references related content including process maps, standard operating procedures, and requirements, and
wherein the description identifies a target usage, a consumer associated with the target usage, and a consumption mode associated with the target usage.

3. The method of claim 1, wherein extracting the first features from a stored item of the first portion comprises:
extracting a first mode of content from the stored item based on a time domain analysis, wherein the first mode of content comprises an optical flow over time; and
extracting a second mode of content from the stored item based on a frequency domain analysis, wherein the second mode of content comprises text converted from speech.

4. The method of claim 1, wherein identifying the correlated features within the first portion of the stored items using natural language content associated with the first features comprises:
applying a cross-attention mechanism to the first portion of the stored items to identify the correlated features.

5. The method of claim 4, wherein the first stored item of the first portion includes a first timestamp associated with an event occurring in the second stored item of the first portion, and
wherein the first timestamp is after a second timestamp associated with a corresponding event in the second stored item of the first portion.

6. The method of claim 5, wherein normalizing the correlated features of the first portion in time based on the correlated features comprises:
updating the first timestamp and the second timestamp to be equivalent with respect to the output structure of the document.

7. The method of claim 1, wherein the first portion of the stored items having the temporal relationship includes a content having a duration based on a plurality of frames that are presented at discrete times or events identified in a structured format with each event including a timestamp, and
wherein the second portion of the stored items that do not have a temporal relationship comprises a content having an unstructured output form or a structured format without a timestamp.

8. The method of claim 1, wherein obtaining the output structure comprises:
identifying the content items for the document using a knowledge graph;
obtaining, from the first LLM, the output structure based on hierarchical ordering of the identified content items; and
in response to determining the content items are not sufficient for the document, obtaining child content items for the document.

9. The method of claim 1, wherein the first LLM is configured to query a knowledge graph representing a domain knowledge having associated with information in a structured form and an unstructured form, wherein the knowledge graph includes pointer to the stored items.

10. The method of claim 1, wherein obtaining the document comprises:
providing a first prompt including a first content item of the content items in the ordered hierarchical structure;
in response to the first prompt, receiving a first response;
generating a second prompt based on a second content item that follows the first content item in sequence and the first response;
in response to the second prompt, receiving a second response; and
providing a third prompt to synthesize the first response and the second response, wherein the document is provided in response to the third prompt.

11. The method of claim 1, further comprising:
validating, using the second LLM, the document based on the description.

12. The method of claim 1, wherein the output structure corresponds to the document type, wherein, when the document type corresponds to a majority of text content, the ordered hierarchical structure of the content items includes a plurality of sections, and each section includes at least one block content, wherein a block content comprises a logical section of information, paragraph, a list, or a table;
wherein, when the document type corresponds to a majority of array-based content, the ordered hierarchical structure of content items includes a plurality of pages, and each page includes a table; and
wherein, when the document type corresponds to a plurality of content types, the ordered hierarchical structure of content items includes a plurality of pages, and each page includes a plurality of media types.

13. A computing device for performing a function, comprising:
at least one memory; and
at least one processor coupled to the at least one memory and configured to:
receive an input associated with a document to be generated, the input including one or more parameters including a document type, a purpose, and a description,
obtain, from a first LLM, an output structure associated with the document, the output structure comprising an ordered hierarchical structure of content items based on the document type;
identify stored items corresponding to the content items of the output structure, wherein the content items indicate a plurality of modal output formats, wherein at least a portion of the stored items include temporal content;
determine a first portion of the stored items having a temporal relationship and a second portion of the stored items that do not have the temporal relationship;
extract first features from the first portion of the stored items and second features from the second portion of the stored items;
identify correlated features within the first portion of the stored items using natural language content associated with the first features, wherein a first correlated event in a first stored item of the first portion is identified as being correlated to a second correlated event in a second stored item of the first portion having a different mode than the first stored item;
normalize the correlated features of the first portion in time based on the correlated features; and
after normalizing the correlated features of the first portion, obtain, from a second LLM, the document based on the first features, the second features, and the output structure.

14. The computing device of claim 13,
wherein the document type identifies a modal output of the document,
wherein the purpose references related content including process maps, standard operating procedures, and requirements, and
wherein the description identifies a target usage, a consumer associated with the target usage, and a consumption mode associated with the target usage.

15. The computing device of claim 13, wherein the at least one processor is configured to:
extract a first mode of content from the stored items based on a time domain analysis, wherein the first mode of content comprises an optical flow over time; and
extract a second mode of content from the stored items based on a frequency domain analysis, wherein the second mode of content comprises text converted from speech.

16. The computing device of claim 13, wherein the at least one processor is configured to:
apply a cross-attention mechanism to the first portion of the stored items to identify the correlated features.

17. The computing device of claim 16, wherein the first stored item of the first portion includes a first timestamp associated with an event occurring in the second stored item of the first portion, and
wherein the first timestamp is after a second timestamp associated with a corresponding event in the second stored item of the first portion.

18. The computing device of claim 17, wherein the at least one processor is configured to:
updating the first timestamp and the second timestamp to be equivalent with respect to the output structure of the document.

19. The computing device of claim 13, wherein the first portion of the stored items having a temporal relationship include a content having a duration based on a plurality of frames that are presented at discrete times or events identified in a structured format with each event including a timestamp, and
wherein the second portion of the stored items that do not have a temporal relationship comprises a content having an unstructured output form or a structured format without a timestamp.

20. A non-transitory computer readable media (CRM) storing instructions thereon, which, when executed by at least one processor of a computing device, cause the computing device configured for generating a document by performing operations comprising:
receiving an input associated with a document to be generated, the input including one or more parameters including a document type, a purpose, and a description,
obtaining, from a first LLM, an output structure associated with the document, the output structure comprising an ordered hierarchical structure of content items based on the document type;
identifying stored items corresponding to the content items of the output structure, wherein the content items indicate a plurality of modal output formats, wherein at least a portion of the stored items include temporal content;
determining a first portion of the stored items having a temporal relationship and a second portion of the stored items that do not have the temporal relationship;
extracting first features from the first portion of the stored items and second features from the second portion of the stored items;
identifying correlated features within the first portion of the stored items using natural language content associated with the first features, wherein a first correlated event in a first stored item of the first portion is identified as being correlated to a second correlated event in a second stored item of the first portion having a different mode than the first stored item;
normalizing the correlated features of the first portion in time based on the correlated features; and
after normalizing the correlated features of the first portion, obtaining, from a second LLM, the document based on the first features, the second features, and the output structure.
